(19) United States
(12) Patent Application Publication
(10) Pub. No.: US 2017/0180007 A1
(43) Pub. Date: Jun. 22, 2017

(54) FAST DEVICE REPLACEMENT SYSTEM

(71) Applicant: SCHNEIDER ELECTRIC USA, INC., Schaumburg, IL (US)

(72) Inventors: Kevin M. Jefferies, Raleigh, NC (US); Benjamin W. Edwards, Rolesville, NC (US); Matthew L. White, Raleigh, NC (US); Alan Freeman, Raleigh, NC (US); Richard Karl Weiler, Wake Forest, NC (US)

(73) Assignee: SCHNEIDER ELECTRIC USA, INC., Schaumburg, IL (US)

(21) Appl. No.: 14/976,116

(22) Filed: Dec. 21, 2015

(51) Int. Cl. H04B 5/00; H04L 12/24

(52) U.S. Cl. CPC H04B 5/0031; H04L 41/0668

(57) ABSTRACT

A system and method for fast device replacement (FDR), where direct replacement of an electronic and/or control device is required with minimum downtime. The electronic or control device to be replaced includes a near field communication (NFC) reader/writer and is located at a specific physical location within the equipment. The system also includes a NFC tag placed at the same specific physical location as the electronic/control device to be replaced. The NFC tag file containing a data parameter set of the electronic/control device most recently associated with the specific physical location. The direct replacement electronic/control device also having a NFC reader/writer and an algorithm for obtaining the NFC tag data parameter set and determining whether to use the data parameter set from the most recent electronic/control device associated with the specific physical location or the local data set of the new direct replacement device.

### FIELD OF THE INVENTION

The invention is generally related to the replacement of industrial control devices and particularly to rapid replacement of a control device to minimize system down time and device setup time.

### BACKGROUND OF THE INVENTION

In the past, replacement of an industrial control device has required that the system be shut down for some period of time while the old device is physically removed from its location and the new device is physically installed and configured to operate in the same manner as the replaced device. The configuration can take place before installation, after installation or a combination of both. In any case this can result in a significant amount of nonproductive down time for the system, particularly if the replacement device requires manual configuration. When using a control system connected over a network, after the new device is physically installed and connected to the network it must be enabled, and then settings can be synchronized. Before it can be enabled it must have some method of pre-identifying its network address in the system. Some devices have a dedicated memory module for recording their settings, stored data and operating parameters. When replacement is required the memory module must be removed from the old device and then installed in the new device. Depending on the location and type of memory module this transfer may need to be done before physically installing the new device. Upon startup some additional steps can be required to actually transfer the stored information from the memory module to the new control device. In many processes even a short downtime can be critical to the process being controlled or the equipment used in the process. Therefore, a fast method of replacing a specific control device with an identical control device at the same location, which requires minimal system downtime would be desirable.

### SUMMARY OF THE INVENTION

The general idea of Fast Device Replacement (FDR) is to minimize downtime. There are many contributors to downtime; an important one is the transfer of settings and configuration parameters to a new replacement device. The present invention provides a system and method for direct replacement and configuration of a control device with minimal downtime.

The system of the present invention for fast device replacement comprises:
a control device having a near field communication (NFC) reader/writer;
a support structure for supporting the control device at a specific physical location on the support structure;
a NFC tag attached to the support structure or immediately adjacent the support structure at or immediately adjacent the specific physical location on the support structure supporting the control device; and
wherein the NFC reader/writer of the control device installed at the specific physical location, upon receiving power, reads stored information specific to the control device installed at the specific physical location from the NFC tag attached at or immediately adjacent the specific physical location.
The method of the present invention comprises:

providing a support structure having a specific location for supporting a control device;

attaching a near field communication (NFC) tag on or immediately adjacent the support structure at or immediately adjacent the specific location for supporting the control device;

installing a control device having a NFC reader/writer at the specific location for supporting a control device;

applying power to the control device installed at the specific location; and

reading, from the NFC tag attached at or immediately adjacent the specific location, by the NFC reader/writer of the control device installed at the specific location, stored information related to the control device installed at the specific location.

### BRIEF DESCRIPTION OF THE DRAWINGS

FIGS. 1A-1E illustrate a DIN rail installation with NFC tags installed.

FIG. 2 illustrates a control center with NFC tags installed.

FIG. 3 is a flow chart showing the steps for rapid replacement of control devices using the method of the present invention.

### DETAILED DESCRIPTION OF THE EMBODIMENTS

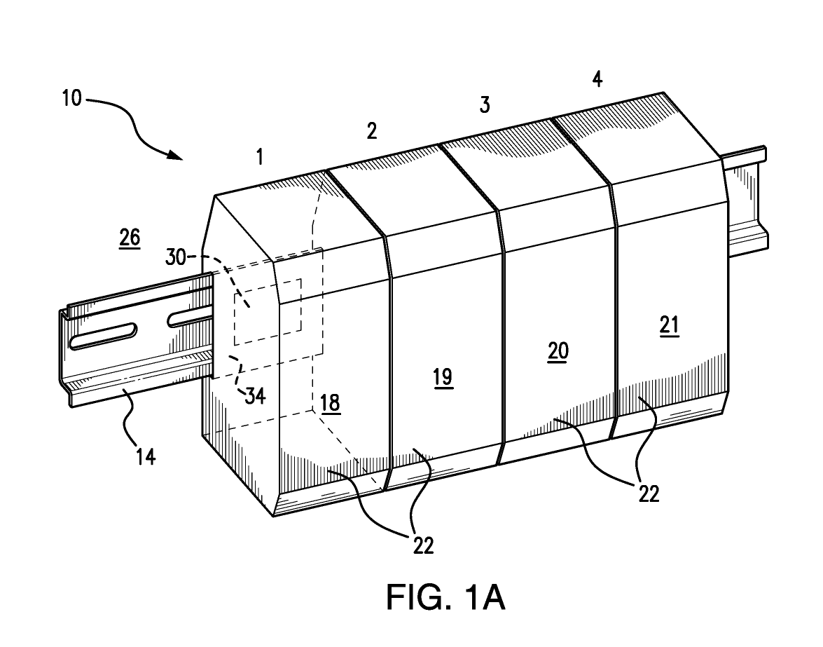

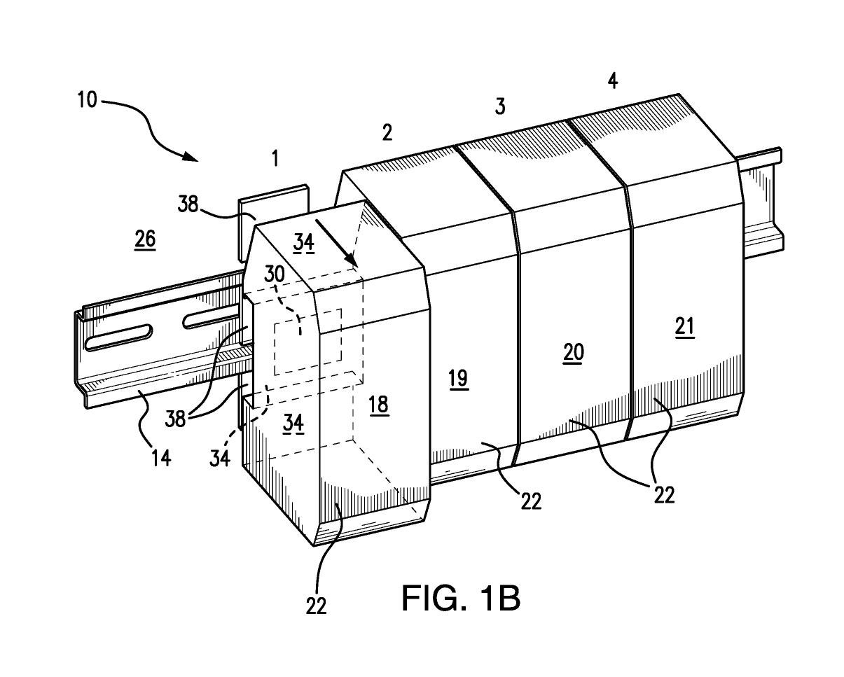

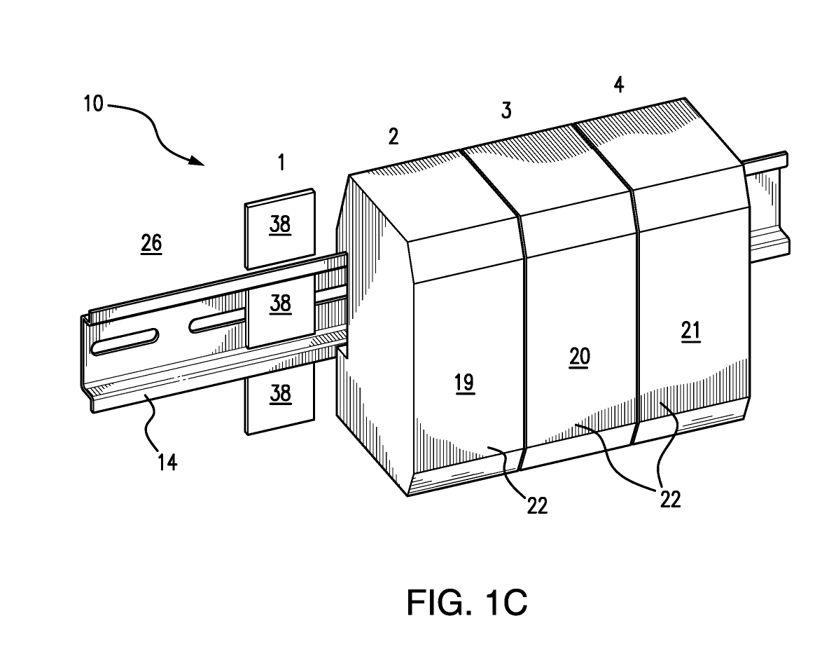

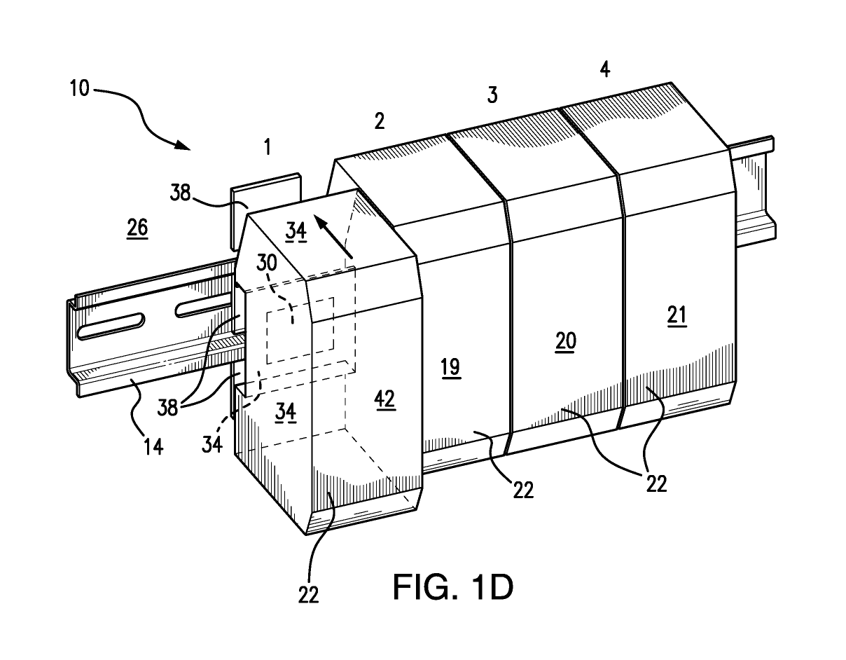

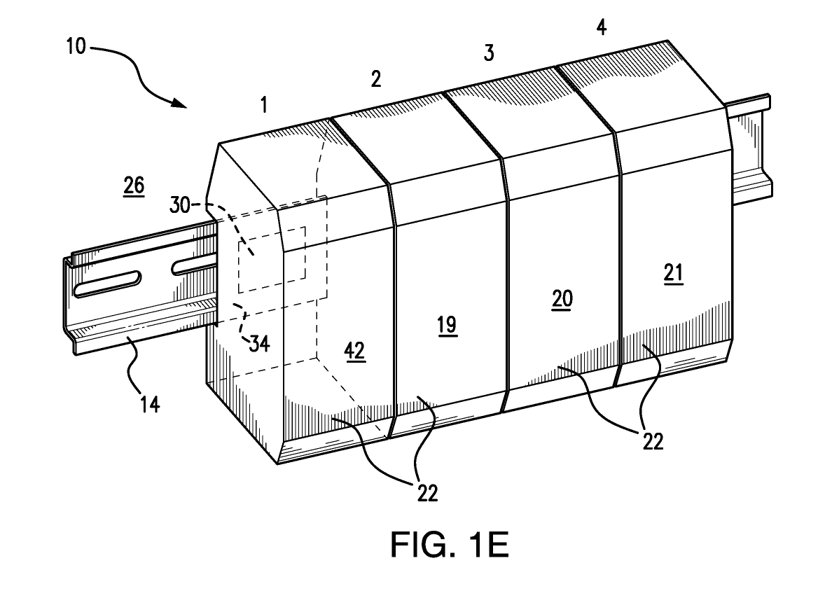

FIGS. 1A-1E illustrate a fast device replacement (FDR) system of the present invention, generally indicated by reference numeral 10, as deployed in a DIN rail 14 mounting application. Several electronic or control devices 18, 19, 20 and 21 (collectively indicated by reference numeral 22) using the FDR system, are installed on the DIN rail 14. It is to be understood that although the term “control device” will be used hereafter it includes all types of electronic devices that are generally assigned a specific location and are subject to direct replacement. DIN rails 14 are generally installed on vertical surfaces, which for the purpose of this discussion will be indicated by reference numeral 26, such as the back or side walls of an enclosure or on a wall of an electrical closet, control room. In some applications the DIN rail 14 can be installed directly on a surface 26 of the equipment being controlled by control devices 22 installed on the DIN rail 14. As can be seen in FIG. 1A, a number of control devices 22 have been installed on DIN rail 14. Indicia placed above the control devices 22 is for the purpose of this discussion, but could be used to easily identify a specific physical location at which individual control devices 22 are located on DIN rail 14. Each control device 22 of the FDR system 10 includes a near field (NFR) reader/writer 30 and each specific physical location associated with a specific one of the control devices 22 includes a NFC tag 38 (FIG. 1B). In this particular embodiment the NFC reader/writer 30 is located on or near a rear surface 34 of each of the control devices 22.

Referring now to FIG. 1B, control device 18 associated with indicia 1 is selected to be replaced. After power to the selected control device 18 has been disconnected the control device 18 can be removed from DIN rail 14. A NFC tag 38 is located either on surface 26 or on DIN rail 14 at a specific physical location associated with control device 18 and indicia 1. The NFC tag 38 located at the specific physical location associated with control device 18 can have recently stored information specific to the selected control device 18 being replaced. In FIG. 1C control device 18 has been removed from DIN rail 14 and possible locations for the NFC tag 38 at the specific physical location associated with control device 18 are clearly seen.

Referring now to FIG. 1D, a new exact replacement control device 42 is being installed to replace control device 18 at the specific physical location associated with control device 18 and indicia 1. New control device 42 includes a NFC reader/writer 30 on or near its rear surface 34.

Referring now to FIG. 1E, the new control device 42 has been installed at the specific physical location previously associated with control device 18 and indicia 1, and now being occupied by and associated with new replacement control device 42. When power is reconnected to control device 42 the NFC reader/writer 30 in control device 42 will immediately check for information stored on NFC tag 38 located at the specific physical location at which control device 18 was installed and where new control device 42 is currently installed.

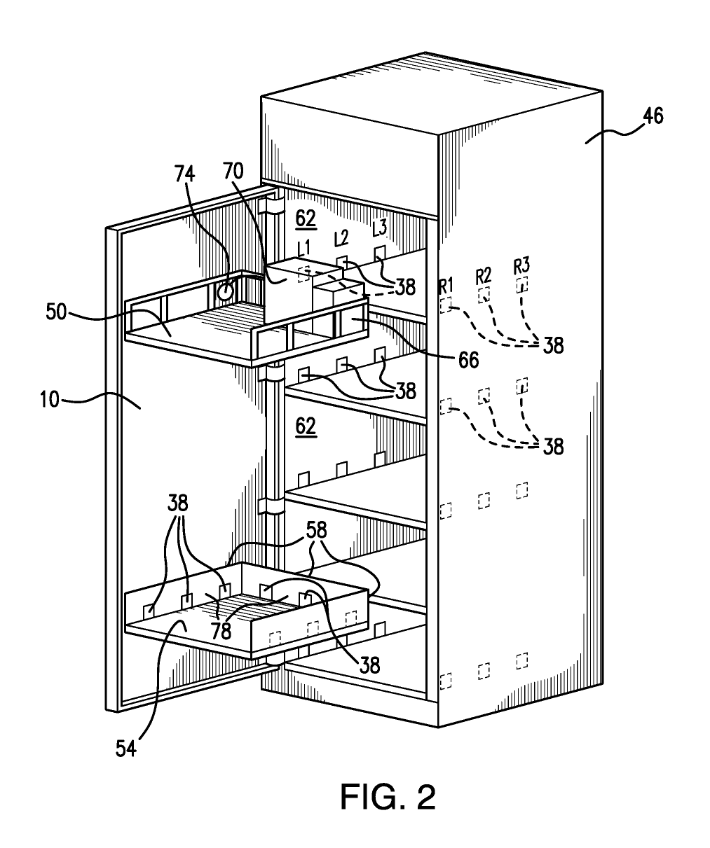

FIG. 2 illustrates the fast device replacement (FDR) system 10 of the present invention, as deployed in a motor control center, enclosed electrical housing or cabinet, generally referred hereafter as an enclosure, and indicated by reference numeral 46. Enclosures 46 are generally provided with racks 50 or trays 54 on which the control devices 22 are assembled. Racks 50 are generally open, frame like structures, while trays 54 are more enclosed structures having side walls 58. The control devices 22 are assembled on the racks 50 at specific physical locations. When racks 50 are used the NFC tags 38 can be attached to the inside surface 62 of the enclosure 46 walls at specific physical locations such as R₁, R₂, R₃, L₁, L₂ and L₃ which coincide with the specific physical locations of the control devices 66 and 70. In FIG. 2, a NFC tag 38 is installed on the surface 62 of the enclosure 46 wall at the specific physical position indicated by indicia R3, such that it will coincide with the specific physical location of control device 66 when rack 50 is in its operating position. In some situations the specific physical location of a control device 22 is not such that a NFC tag 38 can be placed immediately adjacent to it. The specific physical position of control device 70 is such that a NFC tag 38 cannot be positioned to coincide with its specific physical position. Therefore, a remote NFC antenna 74 connected to control device 70 is attached to the rack 50 at a specific physical position that coincides with the specific physical position of NFC tag 38 associated with indicia L3 on inside surface 62 of enclosure 46 when rack 50 is in its operating position.

When trays 54 are used the NFC tags 38 can be attached to the insides surfaces 78 of the tray sides 58 at or immediately adjacent the specific physical positions of control devices 22 installed on trays 54 or by using remote NFC antennas 74.

If the specific physical location of control devices 22 can be accurately determined the NFC tags 38 can be pre-installed on DIN rails 14 and on the inside surfaces 62 of enclosures and inside surfaces 78 of trays 54. The pre-installed NFC tags 38 can be easily pre-programmed with specific operating parameters and information relative to the particular control device 22 which will be installed at the specific physical location of the particular NFC tag 38. Using pre-installed pre-programmed NFC tags 38 can reduce commissioning time.

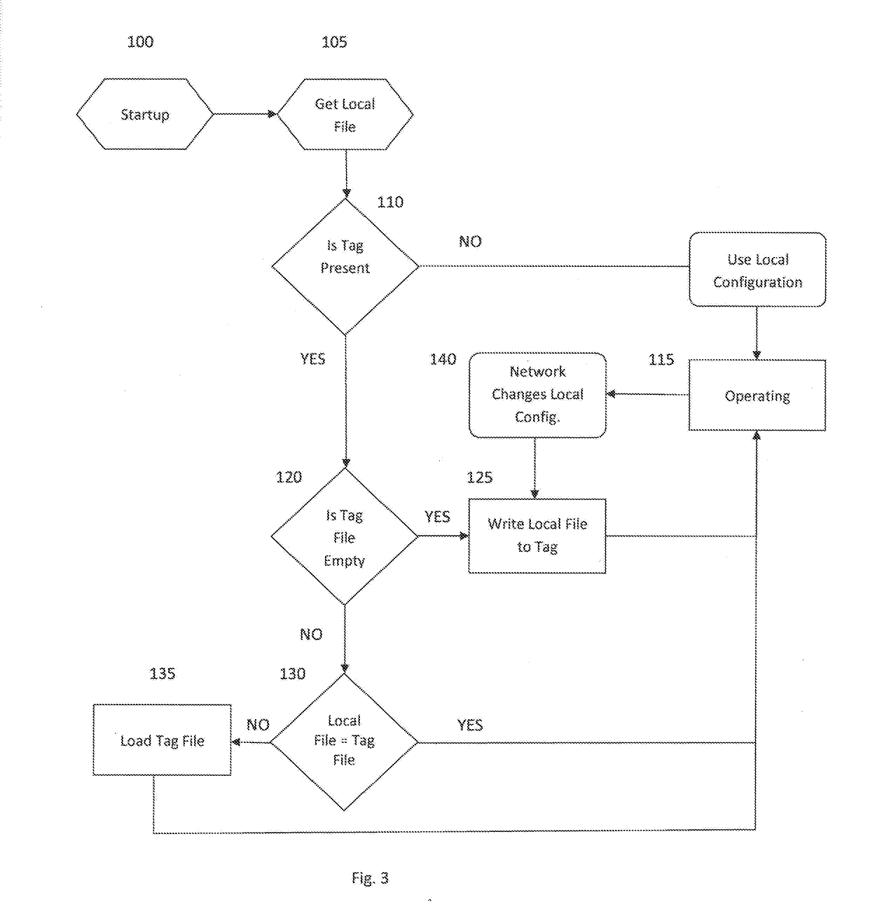

Referring now to the FDR flow chart of FIG. 3, a more detailed description of the FDR system interactions between the NFC tag 22 and control device 22 is described. When power is applied to a control device 22 (step 100) installed in a specific physical location the control device 22 downloads general operating parameters from its local memory (step 105). After the local download is complete its NFC reader/writer 30 initiates contact with a NFC tag 38 associated with the specific physical location in which the control device 22 is installed (step 110). If there is no response from a NFC tag 38 at step 110 the local configuration file is used for operating the control device 22 (step 115). If a NFC tag 38 does respond at step 110 the NFC reader/writer 30 checks to see if there is a configuration file present on the NFC tag 38 (step 120). If the NFC tag 38 does not have a configuration file at step 120 the NFC reader/writer 30 writes the local configuration file to the NFC tag 38 (step 125) and uses the local configuration file for operation of the control device 22 (step 115). If the NFC tag 38 does have a configuration file the NFC tag 38 configuration file is compared to the local configuration file (step 130). If the local configuration file is equal to the NFC tag 38 configuration file at step 130 the local configuration file is used for operation of the control device 22 (step 115). If the local configuration file is not equal to the NFC tag 38 configuration file at step 130 the NFC tag 38 configuration file is downloaded (step 135) and used for operating the control device 22 (step 115). During operation of the control device 22, if there is a configuration change to the local file from the network (step 140) the NFC reader/writer 30 writes the changed local file to the NFC tag 38 (step 125) and uses the changed local file for operating the control device 22 (step 115). The local file and NFC tag 38 file are synchronized each time a change is made to the local file, prior to any planned interruption of operation of the control device 22 and at predetermined intervals. This synchronization ensures that the NFC tag 38 file is current with the local file should any unexpected interruptions occur and if a fast replacement of the control device 22 is required.

1. A system for fast device replacement, comprising:
a control device having a near field communication (NFC) reader/writer;
a support structure for supporting the control device at a specific physical location on the support structure; and
a NFC tag attached to the support structure or immediately adjacent the support structure at or immediately adjacent the specific physical location on the support structure supporting the control device such that the NFC reader/writer of the control device installed at the specific physical location coincides with the NFC tag attached to the support structure at the specific physical location; and
wherein the NFC reader/writer of the control device installed at the specific physical location, upon receiving power, reads stored information related to the control device installed at the specific physical location from the NFC tag attached at or immediately adjacent the specific physical location.

2. The system for fast device replacement of claim 1, wherein the support structure can be a control rack, a DIN rail, an enclosure wall or an equipment surface.

3. The system for fast device replacement of claim 1, wherein the NFC reader/writer of the control device installed at the specific physical location, upon receiving a network change to stored information specific to the control device installed at the specific location, writes the new information to the NFC tag attached at or immediately adjacent the specific physical location.

4. The system for fast device replacement of claim 1, wherein the NFC reader/writer of the control device installed at the specific physical location, upon receiving a notice of a planned interruption of operation, writes its current information specific to the control device installed at the specific location to the NFC tag attached at or immediately adjacent the specific physical location.

5. The system for fast device replacement of claim 1, wherein the NFC reader/writer of the control device installed at the specific physical location, at predetermined intervals, synchronizes its current information specific to the control device installed at the specific location with the NFC tag attached at or immediately adjacent the specific physical location.

6. The system for fast device replacement of claim 1, wherein a pre-installed pre-programmed NFC tag can be used to commission a new control device being installed at the specific physical location on the support structure.

7. (canceled)

8. A method for fast device replacement, comprising:
providing a support structure having a specific location for supporting a control device;
attaching a near field communication (NFC) tag on or immediately adjacent the support structure at or immediately adjacent the specific location for supporting the control device such that the NFC tag will coincide with a NFC reader/writer of the control device being installed at the specific location;
installing the control device having the NFC reader/writer at the specific location for supporting the control device;
applying power to the control device installed at the specific location; and
reading, from the NFC tag attached at or immediately adjacent the specific location, by the NFC reader/writer of the control device installed at the specific location, stored information related to the control device installed at the specific location.

9. The method of claim 8, wherein the NFC reader/writer writes information related to the control device installed at the specific physical location to the NFC tag attached at or immediately adjacent the specific physical location.
